(19) United States
(12) Patent Application Publication
(10) Pub. No.: US 2010/0003544 A1
(43) Pub. Date: Jan. 7, 2010

(54) ELECTROCHEMICAL ENERGY SOURCE, ELECTRONIC DEVICE, AND METHOD MANUFACTURING SUCH AN ELECTROCHEMICAL ENERGY SOURCE

(75) Inventors: Remco Henricus Wilhelmus Pijnenburg, Hoogeloon (NL); Petrus Henricus Laurentius Notten, Eindhoven (NL); Rogier Adrianus Henrica Niessen, Eindhoven (NL); Johanes Hubertus Gerardus Op Het Veld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/375,787

(22) PCT Filed: Jul. 6, 2007
(86) PCT No.: PCT/IB2007/052662

§ 371 Date: Jan. 30, 2009

(30) Foreign Application Priority Data
Aug. 4, 2006 (EP) 06118429.7

(51) Int. Cl. H01M 2/16; H01M 4/58; H01M 4/42; H01M 4/38; B05D 5/12; H01B 13/00

(52) U.S. Cl. 429/7; 429/246; 429/231.95; 429/231.8; 429/218.1; 429/229; 429/226; 427/58; 216/13

(57) ABSTRACT

An electrochemical energy source, comprising: a substrate, and at least one stack deposited onto said substrate, the stack comprising: an anode, a cathode, and an intermediate electrolyte separating said anode and said cathode; and at least one electron-conductive barrier layer being deposited between the substrate and the anode, which barrier layer is adapted to at least substantially preclude diffusion of active species of the stack into said substrate.

### FIELD OF THE INVENTION

The invention relates to an electrochemical energy source, comprising: a substrate, and at least one stack deposited onto said substrate, the stack comprising: an anode, a cathode, and an intermediate electrolyte separating said anode and said cathode; and at least one electron-conductive barrier layer being deposited between the substrate and the anode, which barrier layer is adapted to at least substantially preclude diffusion of active species of the stack into said substrate.

### BACKGROUND OF THE INVENTION

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO2005/027245, where a solid-state thin-film battery, in particular a lithium ion battery, is fabricated directly onto a structured silicon substrate provided with multiple slits or trenches in which an electron-conductive barrier layer, and a stack of a silicon anode, a solid-state electrolyte, and a cathode are deposited successively. The slits or trenches are provided in the substrate to increase the contact surface area between the different components of the stack to improve the rate capacity of the battery. The structured substrate may comprise one or more electronic components to form a so-called system-on-chip. The barrier layer is adapted to counteract diffusion of intercalating lithium into said substrate, which diffusion would result in a significant diminished storage capacity of the electrochemical source. Although the known battery exhibits commonly superior performance as compared to conventional solid-state batteries, the known battery has several drawbacks. It has been found that a major drawback of the known battery is that the manufacturing rate of the known battery is relatively poor due to the relatively critical deposition steps for depositing the barrier layer, the anode, the electrolyte, and the cathode successively in the slits and trenches of the substrate. Consequently, the relatively complex manufacturing process for manufacturing the known battery will commonly lead to a relatively high cost price of the known battery. Another major drawback of the known battery is that the maximum amount of energy which may be stored in the anode is relatively low due to the limited thickness of the anode. Since a silicon anode expands about 400% upon lithium intercalation, the thickness of the anode layer is restricted to 100 nm. In case an anode layer is applied having a layer thickness exceeding this value, this relatively thick anode will commonly crack due to material stresses within the anode during expansion of the anode.

It is an object of the invention to provide an improved electrochemical energy source without suffering from at least one of the drawbacks mentioned above.

### SUMMARY OF THE INVENTION

This object can be achieved by providing an electrochemical energy source according to the preamble, characterized in that the stack and the barrier layer are applied to a substantially flat contact surface of the substrate, and that at least one of the anode and the cathode is provided with at least one material stress reducing cavity. Since the barrier layer and stack are deposited onto a relatively flat and smooth contact surface of the substrate (wherein the substrate is not provided with cavities, such as slits or trenches), the deposition process for depositing different layers of the electrochemical energy source according to the invention onto the substrate can be facilitated significantly. Since the deposition steps are significantly less critical, the electrochemical energy source according to the invention can be manufactured relatively fast which is in favor of the cost price of the energy source. Moreover, by providing one or more material stress reducing cavities adapted to prevent an excessive increase of material stress within the anode and/or cathode during expansion, relatively thick anode layers (over 100 nm) and cathode layers may be applied within the stack, without easily leading to deterioration of the anode and/or cathode during expansion of the anode and/or cathode. In this manner the energy density per unit area of the electrochemical energy source according to the invention can be increased in a relatively simple manner without (conventionally) stacking several battery stacks on top of each other, the latter process being relatively difficult and expensive. Another major advantage of the electrochemical energy source according to the invention, of which energy source the thickness, and hence the design, of the anode and/or the cathode is less critical, is that the degree of freedom of design of this electrochemical energy source is many times larger than this freedom offered by the state of the art. Although it is expected that commonly at least the anode will be provided with one or more material stress reducing cavities, it is also conceivable for a person skilled in the art to provide the cathode with one or more material stress reducing cavities. In this latter case, the cathode will commonly deposited prior to the deposition of the anode, wherein the anode will be connected separately to the substrate after depositing. Therefore, both a regular stack (anode directed towards the substrate) and a reverse stack (cathode directed towards the substrate) can be incorporated in the electrochemical energy source according to the invention. Embodiments of the electrochemical energy source according to the invention described hereinafter comprising an anode provided with at least one material stress reducing cavity could therefore easily be modified to corresponding embodiments in which the cathode is provided with at least one material stress reducing cavity.

In order to reduce the material stress within the anode, in particular during expansion of the anode, as much as possible, it is commonly advantageous in case the anode is provided with multiple material stress reducing cavities. In this manner expansion of the anode in particular due to intercalation of active species, can be counterbalanced in a relatively efficient and commonly relatively homogeneous manner.

The positioning of the one or more material stress reducing cavities is dependent on multiple circumstances among which the size, shape and material of the anode, the size and shape of the cavities, and the intercalation mechanism applied to the stack. In a preferred embodiment one or multiple cavities are substantially completely enclosed by the anode as to form pores. The application of pores within the anode will commonly provide the anode a certain degree of elasticity to counterbalance expansion of the anode. During expansion of the (foamy) anode the pores will commonly be filled up with expanded anode material, as a result of which a built-up of material stress within the anode during expansion can be kept to a minimum. The pores applied may be formed by relatively small open cells which may be generated during manufacturing of the anode.

In an alternative preferred embodiment, the anode is at least partially perforated by the cavities. The perforations may be formed by linear or non-linear channels which commonly extend substantially from a surface of the anode to another, in particular an opposite, surface of the anode. The channels may be oriented either substantially horizontally (in parallel with the substrate), substantially vertically (perpendicularly to the substrate), substantially diagonally (enclosing an angle with the substrate), or otherwise.

In a preferred embodiment at least a part of the cavities is oriented in a contact surface of the anode directed towards the electrolyte. As aforementioned these cavities may be formed by channels or by open surface pores. By providing the contact surface of the anode directed towards the electrolyte with one or multiple cavities, this contact surface will become patterned or structured. In a particular preferred embodiment these (surface) cavities may be formed by slits or trenches. Application of a patterned contact surface area of the anode will not merely improve the capacity of the anode to compensate expansion of the anode material, but may also increase the contact surface area between the anode and the electrolyte. In this way an increased contact surface per volume between the anode the electrolyte can be obtained. Commonly, this increase of the contact surface(s) between the components of the energy source according to the invention leads to an improved rate capacity of the energy source, and hence a better capacity of the energy source (due to an optimal utilization of the volume of the layers of the energy source). In this way the power density in the energy source may be maximized and thus optimized. The nature, shape, and dimensioning of the structure of the contact surface of the anode may be arbitrary. In a particular preferred embodiment at least a part of the electrolyte is deposited into at least a part of the slits to increase the contact surface area between the anode and the electrolyte. In an alternative preferred embodiment the cavities together provide a pillar structure of the contact surface of the anode directed towards the electrolyte. In this embodiment the cavities are mutually connected to each other whereby remaining parts of the contact surface of the anode define a pillar structure. It has been found that pillar structures have a favorable surface-to-volume ratio. The surface-to-volume ratio can be optimized by optimizing the number of pillars to be applied as well as the diameter and height of the pillars. A pillar structure may be made by specific etching techniques, also known as the ‘island lithography’. In this context it is noted that also other structures than pillar structures and/or the application of slits or trenches may be used to increase the contact surface area between the anode and the electrolyte.

The stack preferably further comprises separate current collectors being electrically connected to the anode and the cathode. It is generally known to apply current collectors as electrode terminals. In case e.g. a Li-ion battery with a LiCoO₂ electrode is applied, preferably an aluminum current collector is connected to the LiCoO₂ electrode. Alternatively or in addition a current collector manufactured of, preferably doped, semiconductor such as e.g. Si, GaAs, InP, as of a metal such as platinum, copper or nickel may be applied as current collector in general with solid-state energy sources according to the invention. In case an electron-conductive barrier layer is applied this barrier layer may be used to function as a current collector for the anode.

In a preferred embodiment the barrier layer is preferably at least substantially made of at least one of the following compounds: tantalum (Ta), tantalum nitride (TaN), titanium (Ti), and titanium nitride (TiN). These compounds have as common property a relatively dense structure which is permeable for electrons and impermeable for the intercalating species, among which lithium (ions). The material of the barrier layer is however not limited to these compounds.

Preferably, the electrochemical energy source is formed by at least one battery selected from the group consisting of alkaline batteries and alkaline earth batteries. Alkaline (earth) storage batteries such as nickel-cadmium (NiCd), nickel-metal hydride (NiMH), or lithium-ion (Li-ion) storage batteries are commonly highly reliable, have a satisfying performance, and are capable of being miniaturized. For these advantages, they are used both as the power sources of portable appliances and industrial power sources, depending on their size. Preferably, the at least one electrode of the energy source, preferably formed by battery, is adapted for storage of ions of at least one of following elements: hydrogen (H), lithium (Li), beryllium (Be), magnesium (Mg), copper (Cu), silver (Ag), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of batteries, e.g. Li-ion batteries, NiMH batteries, et cetera.

In a preferred embodiment at least one of the anode and the cathode comprises at least one of the following materials: C, Sn, Ge, Pb, Zn, Bi, Sb, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as electrode, preferably any other suitable element which is assigned to one of groups 12-16 of the periodic table, provided that the material of the electrode is adapted for intercalation and storing of reactive species such as e.g. of those elements as mentioned in the previous paragraph. Moreover, these materials are preferably suitable to undergo an etching process to apply a pattern (holes, trenches, pillars, etc.) on the contact surface of the substrate to increase the contact surface per volume between both electrodes and the solid-state electrolyte.

The electrolyte applied in the energy source of the energy system according to the invention may be based either on ionic conduction mechanisms and non-electronic conduction mechanisms, e.g. ionic conductors for H, Li, Be, Cu, Ag, and Mg. A solid-state electrolyte will commonly be used. However, it is also conceivable to apply a liquid-state electrolyte or a mix of a solid-state and liquid-state electrolyte. An example of a Li conductor as solid-state electrolyte is Lithium Phosphorus Oxynitride (LiPON). Other known solid-state electrolytes like e.g. Lithium Niobate (LiNbO₃), Lithium Tantalate (LiTaO₃), Lithium orthotungstate (Li₂WO₄), Lithium Germanium Oxynitride (LiGeON), Li₅La₃ Ta₂O₁₂ (Garnet-type class), Li₁₄ZnGe₄O₁₆ (lisicon), Li₃N, beta-aluminas, or Li_{1.3}Ti_{1.7}Al_{0.3}(PO₄)₃ (nasicon-type) may also be used as lithium conducting solid-state electrolyte. A proton conducting electrolyte may for example be formed by TiO(OH), or ZrO₂Hₓ. Detailed information on proton conducting electrolytes is disclosed in the international application WO 02/42831. The cathode for a lithium ion based energy source may be manufactured of metal-oxide based materials, e.g. LiCoO₂, LiNiO₂, LiMnO₂ or a combination of these such as. e.g. Li(NiCoMn)O₂. Examples of a second cathode in case of a proton based energy source are Ni(OH)₂ and NiM(OH)₂, wherein M is formed by one or more elements selected from the group of e.g. Cd, Co, or Bi. Commonly, the cathode mentioned afore will not expand significantly during intercalation of active species. However, a lithium bismuth cathode will though expand substantially upon intercalation of active species. In case such a lithium bismuth cathode is applied in the electrochemical energy source according to the invention, preferably this cathode is provided with one or more material stress reducing cavities to minimize a built-up of material stress during expansion of the cathode.

In a preferred embodiment the substrate is at least partially made of silicon. More preferably, a monocrystalline silicon conductive substrate is applied to carry electronic components, such as integrated circuit, chips, displays, et cetera. This crystalline silicon substrate suffers from this drawback that the intercalating active species diffuse relatively easily into said substrate, resulting in a reduced capacity of said energy source. For this reason it is considerably advantageous to apply a barrier layer onto said substrate to preclude said unfavorable diffusion into the substrate. Moreover, the barrier layer commonly is in favor of the electronic conductivity of the current collector.

Although a relatively rigid substrate may be applied to support the barrier layer and the battery stack, preferably a substrate is applied which is substantially flexible. Application of a relatively flexible substrate will commonly improve the freedom of design of the energy source according to the invention. In this manner, it will for example be imaginable to curl up the energy source to obtain an energy source with a substantially cylindrical geometry. A flexible substrate may be made of a polymer, as e.g. KAPTON®, PEEK™, Mylar®, and polyethylene. Alternatively, the substrate may be made of relatively thin metal sheets, in particular one of more thin sheets which are made of at least one of the following metals: copper, aluminum, and nickel.

The invention also relates to an electronic device provided with at least one electrochemical energy source according to the invention. An example of such an electric device is a shaver, wherein the electrochemical energy source may function for example as backup (or primary) power source. Other applications which can be enhanced by providing a backup power supply comprising an energy system according to the invention are for example portable RF modules (like e.g. cell phones, radio modules, et cetera), sensors and actuators in (autonomous) micro systems, energy and light management systems, but also digital signal processors and autonomous devices for ambient intelligence. It may be clear this enumeration may certainly not being considered as being limitative. Another example of an electric device wherein an energy source according to the invention may be incorporated (or vice versa) is a so-called ‘system-in-package’ (Sip). In a system-in-package one or multiple electronic components and/or devices, such as integrated circuits (ICs), chips, displays, et cetera, are embedded at least partially in the substrate, in particularly a monocrystalline silicon conductive substrate, of the electrochemical energy source according to the invention.

The invention further relates to a method according to the preamble, comprising the steps of: A) depositing a barrier layer onto a substantially flat surface of the substrate, B) depositing stack of an anode, an electrolyte, and a cathode onto the substrate, and C) providing at least one of the anode and the cathode with at least one material stress reducing cavity. Preferably, the material stress reducing cavity will be provided (just) after deposition of the cathode and/or the anode, and prior to the deposition of the subsequent layer of the stack. Advantages and preferred embodiments of the electrochemical energy source to be obtained by this method are already elucidated above in a comprehensive manner. Deposition of the individual layers of the energy source can be achieved by means of conventional deposition techniques such as, for example, chemical vapor deposition, physical vapor deposition, and wet chemical deposition, in particular sol-gel deposition.

In a preferred embodiment the anode and/or the cathode is provided with at least one material stress reducing cavity by means of etching during step C). Commonly, a physical and/or chemical etching technique will be used. Preferably, multiple slits or trenches are etched in the anode during step C). In an alternative preferred embodiment, the cavities etched in the anode and/or the cathode during step C) provide a pillar structured surface of the anode. In an alternative preferred embodiment steps B) and C) are carried out simultaneously to form pores within the anode and/or the cathode. Advantages of applying a patterned (or structured) contact surface area of the anode and/or the cathode which is directed towards the electrolyte to be deposited onto the anode and/or the cathode, and/or of applying a porous anode have already been described afore.

### BRIEF DESCRIPTION OF THE DRAWINGS

The invention is illustrated by way of the following non-limitative examples, wherein:

FIG. 1 shows a cross section of a first embodiment of an electrochemical energy source according to the invention,

FIG. 2 shows a cross section of a second embodiment of an electrochemical energy source according to the invention,

FIG. 3 shows a cross section of a third embodiment of an electrochemical energy source according to the invention, and

FIG. 4 shows a schematic view of a monolithic system in package according to the invention.

### DETAILED DESCRIPTION OF EMBODIMENTS

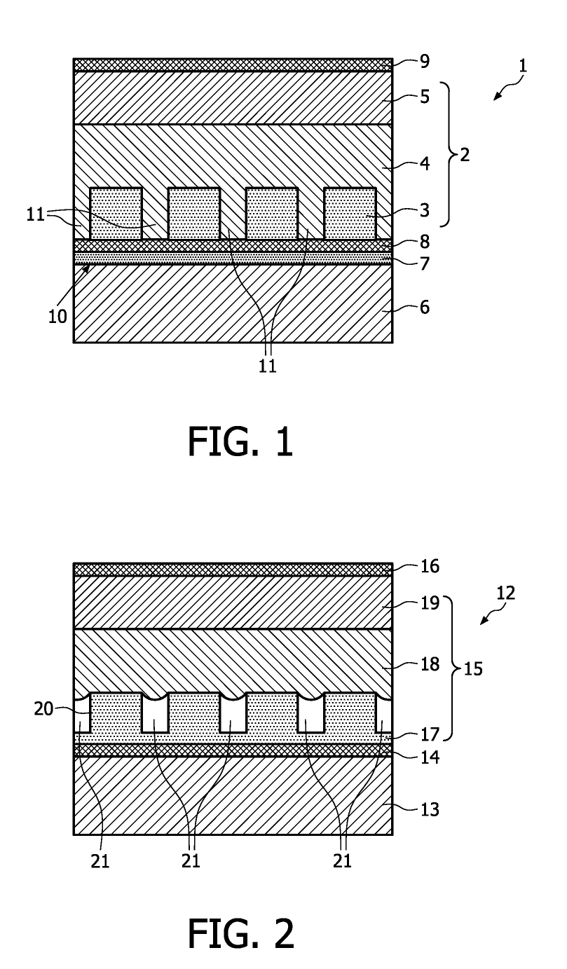

FIG. 1 shows a cross section of a first embodiment of an electrochemical energy source 1 according to the invention. The energy source 1 comprises a lithium ion battery stack 2 of an anode 3, a solid-state electrolyte 4, and a cathode 5, which battery stack 2 is deposited onto a conductive substrate 6 in which one or more electronic components 50 are embedded. In this example the substrate 6 is made of silicon, while the anode 3 is made of amorphous silicon (a-Si). The cathode 5 is preferably made of a metal-oxide, such as LiCoO₂, LiMnO₂, LiNiO₂, et cetera. Between the battery stack 2 and the substrate a lithium barrier layer 7 and a current collector 8 are deposited successively onto the substrate 6. In this example, the lithium diffusion barrier layer 7 is made of tantalum and the current collector 8 is made of platinum. On top of the cathode 5 a second current collector 9 is deposited. Deposition of the individual layers 3, 4, 5, 7, 8, 9 can be achieved, for example, by means of CVD, sputtering, E-beam deposition or sol-gel deposition. Diffusion of lithium ions (or other active species) initially contained by the stack 2 into the substrate 6 can be counteracted by means of the lithium ion barrier layer 7. In case lithium ions would leave the stack 2 and would enter the substrate 6 the performance of the stack 2 would be affected. Moreover, this diffusion would seriously affect electronic component(s) (not shown) embedded within the substrate 6. A shown in FIG. 1 an upper contact surface 10 directed towards the barrier layer 7 is substantially flat to facilitate the deposition process of deposition of the barrier layer 7, the current collector 8, and the anode 3. The anode 3 is provided with multiple cavities 11, in particular perforations, to counterbalance expansion of the anode 3 during lithium intercalation. The cavities 11 are commonly provided by means of conventional etching techniques. As shown the cavities 11 are filled up with electrolyte material in this example. Therefore, preferably a polymer electrolyte 4, or more preferably a liquid-state electrolyte 4 is used to allow expansion of the anode 3, and hence to prevent generation of cracks in the anode 3 upon lithium intercalation. Since the cavities 11 are provided to reduce material stress within the anode 3 caused by expansion of the anode, relatively thick anode layers (over 100 nm) may be applied within the stack 2, without easily leading to deterioration of the anode 3 during expansion of the anode 3. Application of a patterned contact surface area of the anode 3 will not merely improve the capacity of the anode 3 to compensate expansion of the anode material, but may also increase the contact surface area between the anode 3 and the electrolyte 4. In this way an increased contact surface per volume between the anode 3 and the electrolyte 4 can be obtained leading to an improved rate capacity of the energy source 1, and hence a better capacity of the energy source 1. In case at least one electronic component (not shown) is present in the substrate 6, the electrochemical energy source 1 may therefore also be considered as an electrochemical assembly, a system-on-chip, and/or a system-in-package.

FIG. 2 shows a cross section of a second embodiment of an electrochemical energy 12 source according to the invention. The electrochemical energy source 12 comprises a silicon substrate 13 in which one or more electronic components, such as chips or so-called MOSFETs, are embedded. On top of the substrate 13 successively an electron-conductive lithium barrier layer 14, a lithium ion based battery stack 15, and a current collector 16 are deposited. The battery stack 15 comprises an anode 17, an intermediate solid-state electrolyte 18, and a cathode 19. The electron-conductive lithium barrier layer 14 also acts as current collector for the anode 17 in this example. To this end, the barrier layer 14 is preferably made of Ta, Ti, TaN and/or TiN. As shown in this figure, the barrier layer 14 and the anode 17 are deposited onto a relatively flat substrate. The anode 17 comprises a pillar structured upper surface 20 defined by multiple material stress reducing cavities 21. The cavities 21 are provided by means of an etching process performed during though preferably after deposition of the anode 17. The cavities 21 are adapted to counterbalance expansion of the anode 17 upon lithium intercalation. The cavities 21 are kept substantially void in this example to allow a substantially unhindered expansion of the anode 17. To prevent the electrolyte 18 to bleed into the cavities 21, preferably a solid-state electrolyte 18 is used.

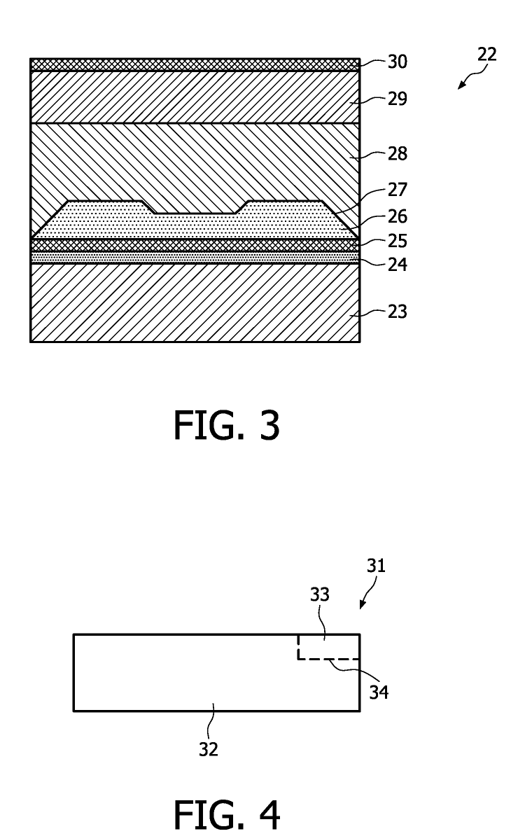

FIG. 3 shows a cross section of a third embodiment of an electrochemical energy source 22, in particularly a lithium ion battery according to the invention. The energy source 22 comprises a substantially planar substrate 23 in which one or more electronic components may be embedded. The substrate 23 is made of a substantially flexible material, such as KAPTON®. On top of the substrate 23 a lithium barrier layer 24, a first current collector 25, and an anode 26 are deposited successively. The anode 26 is made of a porous material to provide the anode 26 a certain elastic capacity to counterbalance expansion of the anode upon intercalation of lithium. An upper surface 27 of the anode 26 is given a structure by means of known techniques, such as etching, to improve the capacity of the anode 26 to compensate expansion of anode material upon intercalation of lithium. Moreover, the patterned upper surface 27 of the anode 26 provides an increased contact surface area with respect to an electrolyte 28 which is deposited onto said anode 26. Subsequently, a cathode 29, and a second current collector 30 are deposited on top of the other layers. The nature and porosity of the anode material may vary and are dependent on situational circumstances.

FIG. 4 shows a schematic view of a monolithic system in package (SiP) 31 according to the invention. The SiP 31 comprises an electronic module or device 32 and an electrochemical energy source 33 according to the invention coupled thereto. The electronic module or device 32 and the energy source 33 are substantially separated by a barrier layer 34. Both the electronic module or device 32 and the energy source 33 are mounted and/or based on the same monolithic silicon substrate (not shown). The electronic module or device 32 can for example be formed by a display, a chip, a control unit, et cetera. In this way numerous autonomous (ready-to-use) devices can be realized in a relatively simple manner.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. An electrochemical energy source, comprising:
a substrate,
at least one stack deposited onto said substrate, the stack comprising:
an anode,
a cathode, and
an intermediate electrolyte separating said anode and said cathode; and
at least one electron-conductive barrier layer being deposited between the substrate and the anode, the barrier layer least substantially precluding diffusion of active species of the stack into said substrate, wherein the stack and the barrier layer are applied to a substantially flat contact surface of the substrate, and least one of the anode and the cathode is provided with at least one material stress reducing cavity.

2. Electrochemical energy source according to claim 1, wherein at least one of the anode and the cathode is provided with multiple cavities.

3. Electrochemical energy source according to claim 1, wherein at least a part of the cavities forms pores.

4. Electrochemical energy source according to claim 1, wherein at least one of the anode and the cathode is at least partially perforated by the cavities.

5. Electrochemical energy source according to claim 1, wherein at least a part of the cavities is oriented in a contact surface of at least one of the anode and the cathode directed towards the electrolyte.

6. Electrochemical energy source according to claim 5, wherein at least a part of the cavities forms slits.

7. Electrochemical energy source according to claim 6, wherein at least a part of the electrolyte is deposited into at least a part of the slits.

8. Electrochemical energy source according to claim 5, wherein the cavities provide a pillar structure of the contact surface of at least one of the anode and the cathode directed towards the electrolyte.

9. Electrochemical energy source according to claim 1, wherein at least one of the anode and the cathode is coupled to a current collector.

10. Electrochemical energy source according to claim 1, wherein the at least one barrier layer is made of at least one of the following materials: Ta, TaN, Ti, and TiN.

11. Electrochemical energy source according to claim 1, wherein at least one of the anode and the cathode contains ions of at least one of following elements: H, Li, Be, Mg, Cu, Ag, Na and K.

12. Electrochemical energy source according to claim 1, wherein at least one of the anode and the cathode is made of at least one of the following materials: C, Sn, Ge, Pb, Zn, Bi, Sb, and doped Si.

13. Electrochemical energy source according to claim 1, wherein the electrolyte is one of a solid-state electrolyte and a liquid-state electrolyte.

14. (canceled)

15. Electrochemical energy source according to claim 1, wherein the substrate comprises Si.

16. Electrochemical energy source according to claim 1, wherein the substrate is substantially flexible.

17. An electronic provided with at least one electrochemical energy source that includes:
a substrate,
at least one stack deposited onto said substrate, the stack including an anode, a cathode and an intermediate electrolyte separating said anode and said cathode; and
at least one electron-conductive barrier layer being deposited between the substrate and the anode, the barrier layer substantially precluding diffusion of active species of the stack into said substrate, wherein the stack and the barrier layer are applied to a substantially flat contact surface of the substrate, and at least one of the anode and the cathode is provided with at least one material stress reducing cavity.

18. Electronic device according to claim 17, further comprising at least one electronic component at least partially embedded in the substrate of the electrochemical energy source.

19. (canceled)

20. A method of manufacturing an electrochemical energy source, comprising the steps of:
depositing a barrier layer onto a substantially flat surface of the substrate,
depositing a stack of an anode, an electrolyte, and a cathode onto the substrate, and
providing at least one of the anode and the cathode with at least one material stress reducing cavity.

21. Method according to claim 20, wherein at least one of the anode and the cathode is provided with at least one material stress reducing cavity by etching.

22. Method according to claim 21, wherein multiple slits are etched in at least one of the anode and the cathode.

23. Method according to claim 21 of wherein cavities etched in at least one of the anode and the cathode provide a pillar structured surface of the anode.

24. Method according to claim 20, wherein the pores are formed substantially simultaneously within at least one of the anode and the cathode.
